(19) United States
(12) Patent Application Publication
(10) Pub. No.: US 2008/0204269 A1
(43) Pub. Date: Aug. 28, 2008

(54) Programmable remote control apparatus and method thereof

(76) Inventor: Donald Wu, Taipei (TW)

Correspondence Address: BACON & THOMAS, PLLC, 625 SLATERS LANE, FOURTH FLOOR, ALEXANDRIA, VA, 22314, US

(21) Appl. No.: 11/709,685

(22) Filed: Feb. 23, 2007

(51) Int. Cl. G05B 19/04

(52) U.S. Cl. 340/825.22

(57) ABSTRACT

A remote control apparatus includes a casing with several function key modules, a setup key, two display units, two switching key modules corresponding to the display units, a function key module for setting remote control contents, and several switching keys. The casing has a circuit board and a control unit on the circuit board for connecting the display units, switching key modules, setup key and function key module. After the setup key is triggered to enter into a setting mode, the control unit displays the content information on the display unit and proximate to the switching key and records the content information and switching key code, and then defines and records the remote control content for each function key module corresponding to at least one switching key. Therefore, users can distinguish the switching keys, corresponding content information, and operation instructions of function key modules corresponding to different switching keys.

### FIELD OF THE INVENTION

The present invention relates to a remote control apparatus, and more particularly to a programmable remote control apparatus capable of setting its remote control contents and a method thereof.

### BACKGROUND OF THE INVENTION

As information technology advances and electronic industry blooms, various different high-tech products are derived from computers and electronic devices are developed rapidly, and these products bring tremendous convenience to our life. At present, electronic technologies are developed and advanced constantly, and thus people have increasingly higher demand on different types of electronic consumer products. Particularly, wireless technology becomes very popular in recent years, and all kinds of equipments or electronic appliances such as automobiles, refrigerators, and televisions are equipped with a wireless control device for reducing the operating time, so as to achieve the effects of lowering the operating cost and enhancing the operating convenience.

Referring to FIG. 1 for a conventional remote controller, the remote controller has a casing 500, and the casing 500 includes a plurality of press keys 501, and the casing 500 installs a circuit board 502 therein, and the circuit board 502 includes a matrix circuit 503, an encoding unit 504 and an IR transmitting unit 505. If one of the press keys 501 is pressed, the press key 501 will trigger the matrix circuit 503 to generate a key pulse signal, and the encoding unit 504 will generate a corresponding code according to the key pulse signal, and the IR transmitting unit 505 will convert the code into a transmission signal and then send out the transmission signal. An electronic device 600 that receives the transmission signal includes an IR receiving unit 601, a decoding unit 602 and a control module 603, wherein the IR receiving unit 601 receives the transmission signal, and the decoding unit 602 decodes the transmission signal to obtain a code carried by the transmission signal, and the control module 603 receives the code outputted by the decoding unit 602 and outputs a control signal according to the received code and drives the electronic device 600 to produce a corresponding action according to the control signal.

For example, the conventional remote control apparatus and electronic device are a television remote controller and a television respectively. If a user wants to turn on the television, the user can press a press key corresponding to the power on of the television remote controller, and then press another press key to operate the television (such as power on/off, adjust the volume, or select a channel, etc) without walking near the television. Users simply press the press keys installed on the remote controller to operate the television, and thus the remote controller brings tremendous convenience to users. However, remote controllers usually have the following problems after it has been used for a period of time:

1. For the same electronic device, only a corresponding remote controller can be used. If the remote controller is missing or damaged, users have to buy the same type of remote controller. Sometimes, such remote controller has been phased out for a long time, and users may be unable to get the remote controller for the electronic device, and they may choose to buy a new television.

2. The press keys of the remote controller may have poor contacts or damages when they get dirty or are operated improperly.

If a remote controller has any of the aforementioned problems, the remote controller will become inconvenient and adversely affect the manufacturers of the electronic products. Therefore, some manufacturers (including Trans Electric Co., Ltd., Website: http://www.px.com.tw/) developed a universal remote controller (such as Trans Electric's RC-500 universal remote controller), and the universal remote controller builds in a remote controller encoding table for various models of different brands of different electronic products (including television, air-conditioner, DVD player, and other home electric appliances) in advance, so that users can search the appropriate remote controller encoding table according to the corresponding brand, model and product type, or users can use “auto-search setup”, “code setup” or “home appliances interchangeable operation” for the setup. Such arrangement determines the key pulse generated by a matrix circuit when each press key of the universal remote controller is pressed, and the encoding unit generates a corresponding code according to one of the product encoding tables, so that the universal remote controller can carry out the remote-controlled operation for at least one product.

However, various different brands of electronic products are introduced constantly to the market, and the encoding tables of the universal remote controller is very limited, and thus the universal remote controller cannot perform the remote-controlled operation for all electronic products, or the press keys of the universal remote controller are limited and cannot cover all required functions of different electronic products. In other words, the universal remote controller cannot output all remote-control signals of the home electric appliances and cause tremendous inconvenience and troubles, even if a universal remote controller has the encoding tables of different remote controllers, but the remote controller encoding tables are not updated. In view of the problems on the use of universal remote controllers, some manufacturers developed a smart remote controller, such as Logitech's Harmony 882 and Harmony 552, and Sony's RM-LJ304, and RM-AX4000. The smart remote controller is a learning remote controller that comes with programmable operating functions for receiving and memorizing remote-control signals issued by traditional remote controllers, and matches a received remote-control signal with a learning press key of the learning remote controller, so that the learning remote controller can learn the remote-control signal corresponding to the learning press key. Thereafter, the learned remote-control signals can be enabled by pressing the learned press keys. For example, Logitech's Harmony 882 and Sony's RM-LJ304 and RM-AX4000 remote controllers come with a touch screen with a plurality of touch learning keys to increase the insufficient number of press keys of the universal remote controllers, but these smart remote controllers still have the following shortcomings:

1. The selling price of a general universal remote controller ranges from USD3 to USD10, but Sony's RM-LJ304 learning remote controller is sold at a price over USD150. There is a huge price gap, since the manufacturing cost of a touch screen is very high. In addition, the learning remote controller requires an additional software design to define and layout all of the touch learning keys on the touch screen, and the cost for the software design and development is high as well, and thus the selling price of these remote controllers remains so high.

2. The smart learning remote controller has a touch screen comprised of many different components, such that after the smart remote controller has installed the touch screen, the height of the smart learning remote controller becomes much higher than the traditional remote controller, and the volume of the smart learning remote controller becomes large, and such increase is unfavorable to the present trend of developing products with a short, small, thin and light design.

As to the smart learning remote controllers with mechanical keys, the remote controller includes a casing having a plurality of mechanical learning keys, and a plurality of words separately printed at the bottom of the casing and proximate to the mechanical learning keys to indicate the represented remote control function, and memorizing the functions to the corresponding mechanical learning keys. Although these remote controllers do not have the aforementioned shortcomings of a smart remote controller with a touch screen, their applications still have the following problems:

1. The words are printed at the bottom of the mechanical learning keys and cannot be altered by users.

2. Most of the words printed at the bottom of the mechanical learning keys come with a number of remote control functions to meet user's requirements, but the printed words are too small and unreadable by users with poor eyesight.

3. User may find insufficient number of press keys for their application, and they usually set irrelevant functions corresponding to the words printed at the bottom of the mechanical learning keys. If another user is using the learned remote control functions which have not been set for the mechanical learning keys, the user may mistaken that the mechanical learning keys are defined with the remote control functions indicated by the words printed at the bottom of mechanical learning keys, or may even forget such remote control functions, and all of the above cause inconvenience and troubles to the use of a smart remote controller with mechanical keys.

In summation of the description above, a conventional remote controller, a smart remote controller with a touch screen, or a smart remote controller with mechanical keys generally has the aforementioned problems. Therefore, users would like to have a remote controller that can overcome the shortcomings of different types and models of remote controllers.

### SUMMARY OF THE INVENTION

In view of the foregoing shortcomings of the prior art, the inventor of the present invention based on years of experience in the related industry to conduct extensive researches and experiments, and finally developed a programmable remote control apparatus and a method thereof, in hope of overcoming the shortcomings of the prior art and contributing its innovation to the general public.

It is a primary objective of the present invention to provide a remote control apparatus for setting remote control contents, and the remote control apparatus comprises a casing having a plurality of function key modules, a setup key, two display units, two switching key modules, each corresponding to one of the display units, a function key module for setting remote control contents, and a plurality of switching keys disposed around each display unit. The casing installs a circuit board therein and a control unit on the circuit board for connecting each display unit, switching key module and setup key and function key module. After the setup key of the remote control apparatus is triggered to enter into a setting mode, the control unit displays the user-defined content information at a position proximate to the switching key on the display unit and records the user-defined content information and the corresponding switching key code, and then defines the remote control content for each function key module corresponding to at least one switching key, and records the remote control content into the remote control apparatus. Therefore, users can distinguish the switching keys, their represented content information, and different operation instructions of the function key modules corresponding to different switching keys.

Another objective of the present invention is to provide a method of setting remote control content applied to a remote control apparatus having two display units, and the method comprises the steps of: letting the remote control apparatus provide user-defined content information represented by the switching key installed on the remote control apparatus and corresponding to different display units; displaying the user-defined content information on the display unit and at the position proximate to each switching key; recording the user-defined content information and their corresponding switching key codes into the remote control apparatus; providing the remote control contents represented by the function key module installed on the remote control apparatus for defining each switching key; and recording the function key module corresponding to at least one switching key into the remote control, after each operation instruction is defined.

To make it easier for our examiner to understand the objective, technical characteristics and effects of the present invention, a preferred embodiment will be described with accompanying drawings as follows:

### BRIEF DESCRIPTION OF THE DRAWINGS

FIG. 1 is a schematic block diagram of a prior art;

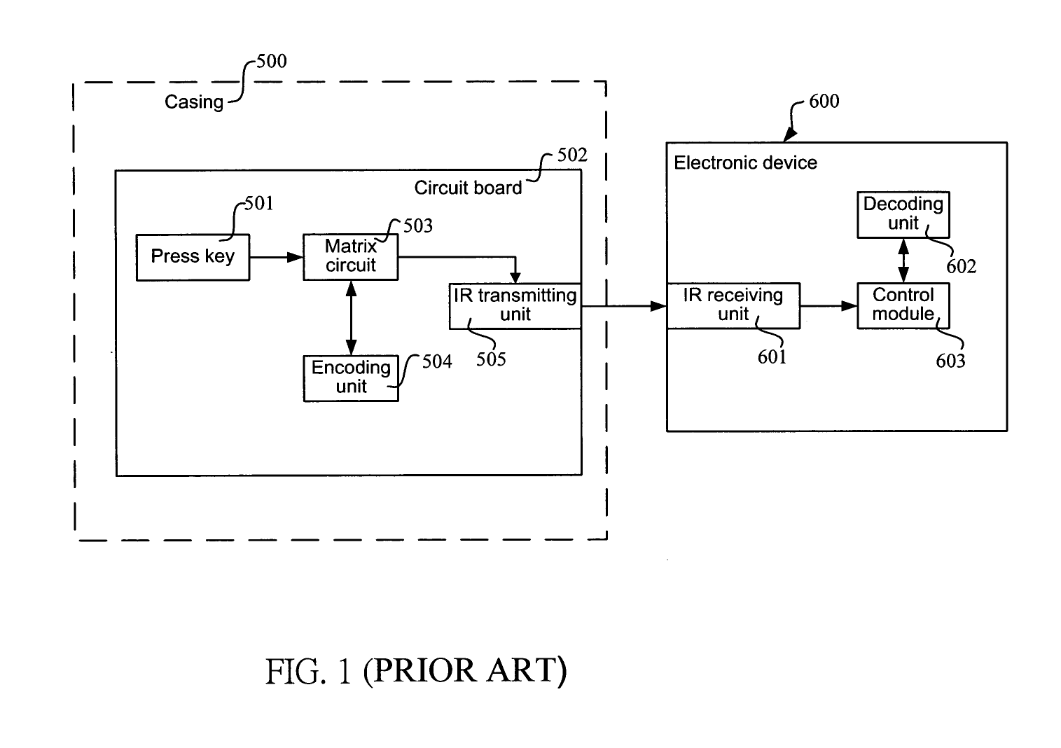

FIG. 2 is a schematic view of a programmable remote control apparatus of the present invention;

FIG. 3 is a schematic block diagram of a programmable remote control apparatus of the present invention;

FIG. 4 is a flow chart of a method for setting remote control contents in accordance with the present invention;

FIG. 5 is a flow chart of a method for setting remote control contents in accordance with a preferred embodiment of the present invention; and

FIG. 6 is a flow chart of a method for setting remote control contents in accordance with another preferred embodiment of the present invention.

### DETAILED DESCRIPTION OF THE PREFERRED EMBODIMENTS

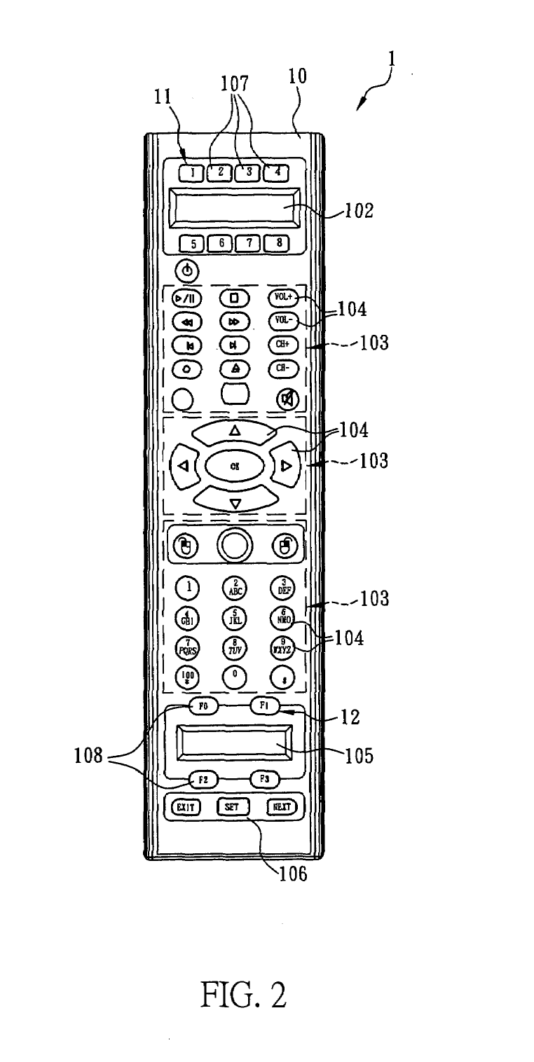

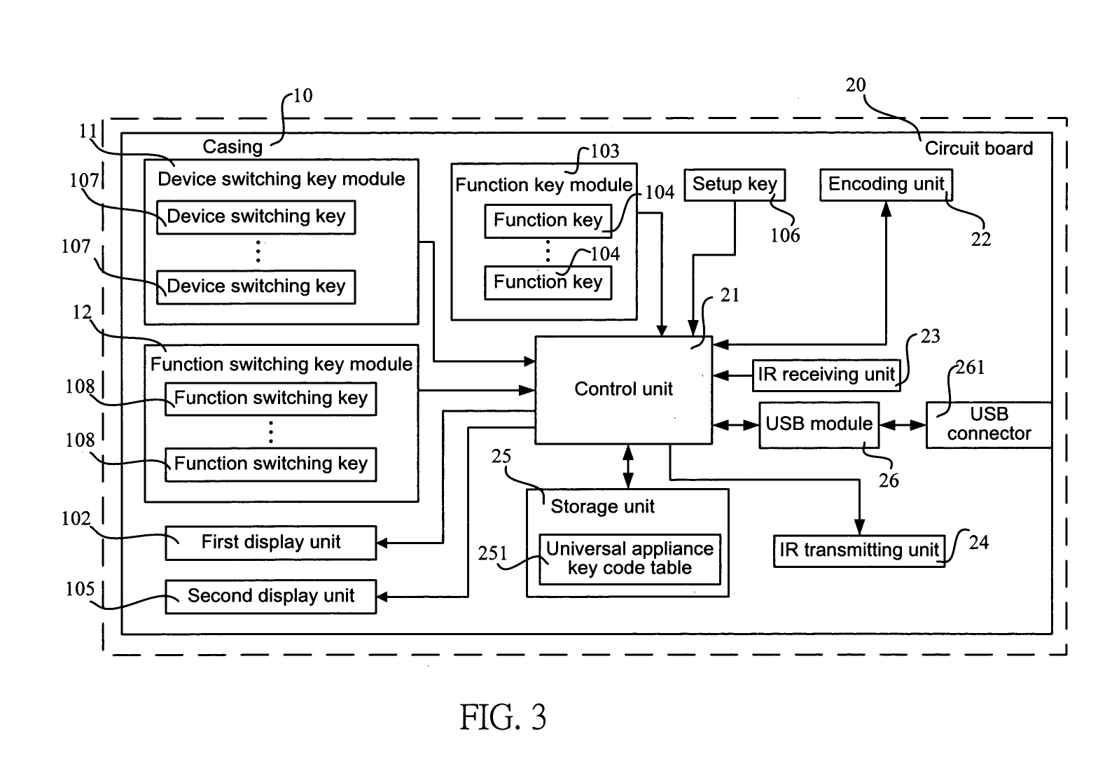

Referring to FIGS. 2 and 3 for a remote control apparatus for setting user-defined remote control contents and its method in accordance with a preferred embodiment of the present invention, the remote control apparatus 1 has a casing 10, and the casing 10 comprises a plurality of function key modules 103 (including a multimedia playback key, a multi-directional control key, a mouse function control key and an alphanumeric key), at least one setup key 106 (including Previous, Next and Exit keys), a first display unit 102, second display unit 105 (such as a liquid crystal display, LCD), a device switching key module 11 and a function switching key module 12. The device switching key module 11 corresponds to the first display unit 102 and a function key module 103 of the user-defined remote control contents, and includes a plurality of device switching keys 107 disposed around each first display unit 102, and the function switching key module 12 corresponds to the second display unit 105 and sets the function key module 103 of the user-defined remote control contents and includes a plurality of function switching keys 108 around the second display unit 105. The function key modules 103 include a plurality of function keys 104 (such as a playback key, an OK key, and a left button of a mouse), and each function key 104 represents a different operating function. After a function key 104 is triggered, a different operation instruction representing such particular function key 104 is performed. After a device switching key 107 is triggered, a different switching key code is issued. The switching key code notices the remote control apparatus 1 to switch to an operation instruction corresponding to the function key module 103. When the first display unit 102 (or second display unit 105) is operated, a content information (such as TV, A/C, DVD, PC, Projector, Stereo, or Tuner function) represented by each device switching key 107 (or a function switching key 108) is displayed on the device switching key 107 (or the function switching key 108) proximate to the first display unit 102 (or the second display unit 105), so that a user can clearly identify and use the content information representing different device switching keys 107 (or function switching keys 108) on the first display unit 102 (or the second display unit 105).

The casing 10 installs a circuit board 20 therein, and the circuit board 20 further comprises a control unit 21 (such as a microcontroller, MCU), an encoding unit 22, an IR receiving unit 23, an IR transmitting unit 24, a storage unit 25 and a USB module 26. The control unit 21 is connected to each component on the circuit board 20 through the circuit board 20. The IR receiving unit 23 is provided for receiving an external transmission signal, and the decoding unit is provided for decoding the transmission signal to obtain a code carried by the transmission signal or the IR transmitting unit 24 sends out the transmission signal, and the control unit 21 is provided for receiving the code outputted by the decoding unit and driving the electronic device to take a corresponding action according to the received encoded outputted control signal and the control signal, or storing a control signal of the switching key into the storage unit 25 as a basis for the code of the switching key for the next time. In addition to storing a control signal corresponding to the switching key, the storage unit 25 also builds in a universal appliance key code table 251 to record different codes according to different types, models and functions of various types of electric appliances. Further, the USB module 26 is connected to an external computer system that can be connected to the Internet through a USB connector 261 on the casing 10 to obtain updated codes, or store a code to the computer system. After a user triggers the setup key 106 on the casing 10, a setup signal will be issued to the control unit 21, and the control unit 21 will enter the remote control apparatus 1 into a setting mode, and then provide users a position on the first display unit 102 (or the second display unit 105) and proximate to the device switching key 107 (or the function switching key 108) to input a content information representing the device switching key 107 (or a function switching key 108), and the control unit 21 records the content information corresponding to the first key code into the storage unit 25, while displaying the content information at a position on the first display unit 102 (or the second display unit 105) and proximate to the device switching key 107 (or the function switching key 108), and then starts setting an operation instruction corresponding to the device switching key 107 (or the function switching key 108), so that a content information representing a different device switching key 107 (or function switching key 108) can be displayed clearly at a position on the first display unit 102 (or second display unit 105) and proximate to the device switching key 107 (or function switching key 108).

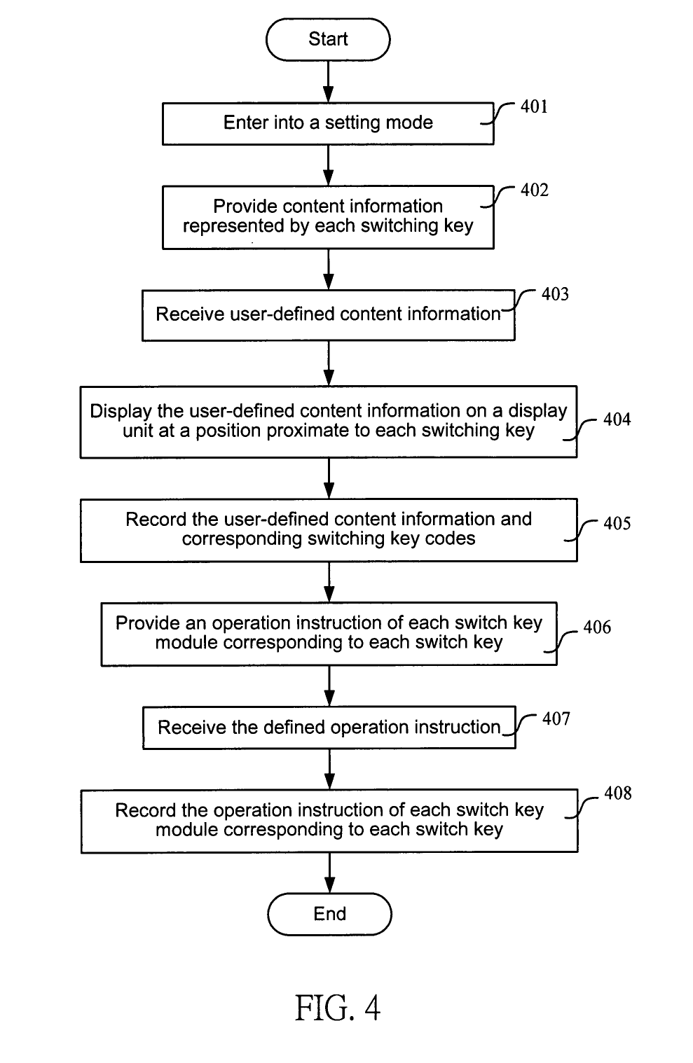

Referring to FIG. 4 for a method of setting user-defined remote control contents in accordance with the present invention, the remote control apparatus 1 carries out a procedure comprising the steps of:

(401) entering into the setting mode;

(402) providing a user-defined content information representing each device switching key 107 (or function switching key 108);

(403) receiving the user-defined content information;

(404) displaying the user-defined content information on the first display unit 102 (or second display unit 105) at a position proximate to each device switching key 107 (or function switching key 108);

(405) recording the user-defined content information and a key code corresponding to the device switching key 107 (or function switching key 108) into the storage unit 25;

(406) providing a user-defined operation instruction for each device switching key 107 (or function switching key 108) corresponding to the function key module 103;

(407) receiving the user-defined operation instruction; and

(408) recording the user-defined operation instruction of a function key module 103 corresponding to at least one device switching key 107 (or function switching key 108) into the remote control apparatus 1.

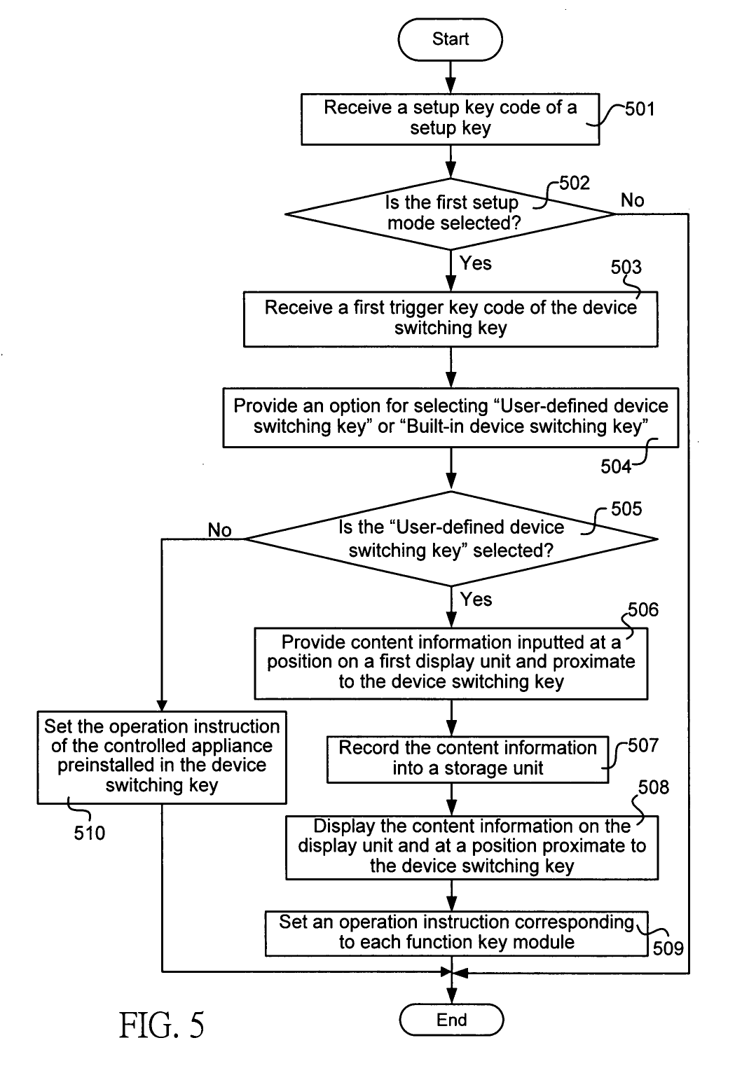

In this embodiment as shown in FIGS. 2 and 3, each device switching key 107 proximate to the first display unit 102 represents a controlled appliance, and the device switching key 107 can be switched, and the control unit 21 can identify an operation instruction representing a specific controlled appliance corresponding to a device switching key 107, and a function switching key proximate to the second display unit 105 represents a unique operation instruction, and the function switching key 108 can be switched, and the control unit 21 can identify a unique operation instruction representing a specified function switching key 108. To distinguish the remote control contents defined by users to represent each device switching key 107 or function switching key 108, a first setting mode and second setting mode are provided. In FIG. 5, the control unit 21 processes a procedure comprising the steps of:

(501) receiving a setup key code issued by a setup key 106 to obtain a desired user-defined device switching key 107 or function switching key 108, after the setup key 106 is triggered;

(502) providing a first menu for clicking or selecting the first setting mode or second setting mode on the first display unit 102 and determining whether or not a user selects the first setting mode; if yes, then go to Step (503), or else end this procedure;

(503) receiving a first trigger key code, after the desired device switching key 107 is triggered;

(504) displaying a second menu for setting a user-defined device switching key or a built-in device switching key on the first display unit 102;

(505) determining whether or not a first signal of a selected option “User-defined device switching key” is received; if yes, then go to Step (506), or else go to Step (510);

(506) providing users a position on the first display unit 102 proximate to each device switching key 107 to input or edit a content information (such as a DVD player) representing the device switching key 107 according to the device switching key 107 represented by the first trigger key code;

(507) recording the first trigger key code and its corresponding content information into the storage unit 25;

(508) displaying the inputted or edited content information on the first display unit 102 and at a position proximate to the device switching key 107 to remind users about the controlled appliance represented by the device switching key 107;

(509) setting an operation instruction corresponding to each function key module 103 according to the function of the controlled appliance; for example, a test key code is issued to the controlled appliance continuously according to a universal appliance key code table 251 in the storage unit 25, until the controlled appliance can be operated; and

(510) setting an operation instruction of a controlled appliance for a built-in device switching key 107 according to the universal appliance key code table 251.

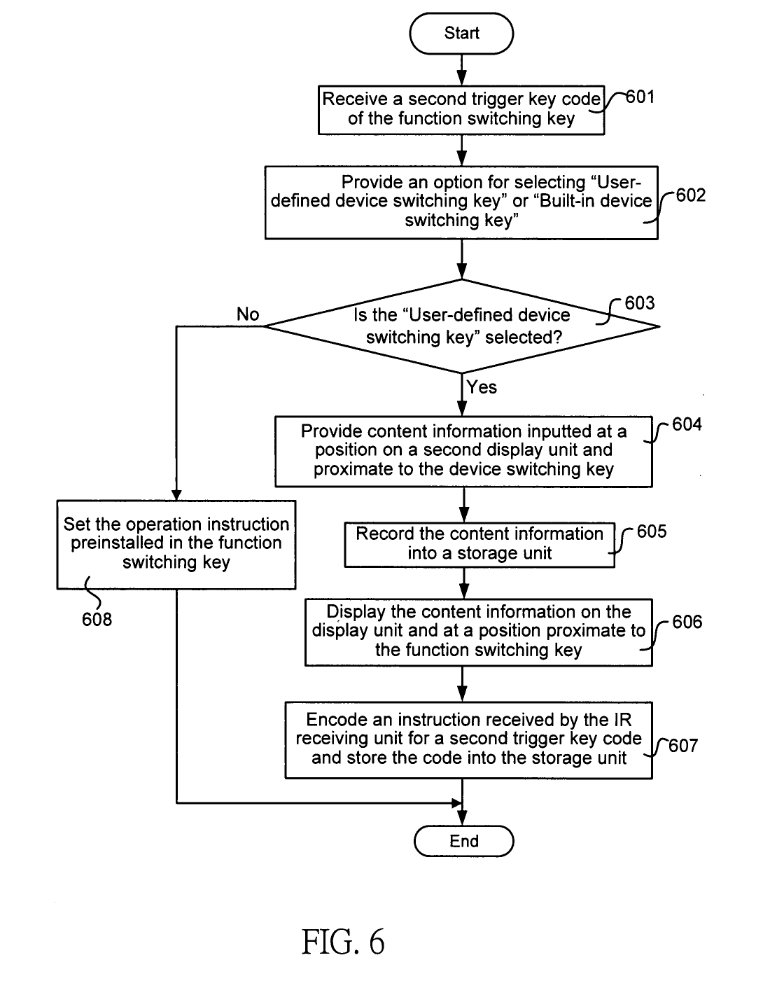

If a user selects the second setting mode as shown in FIGS. 2 and 3, the control unit 21 will carry out the following procedure according to the second setting mode as shown in FIG. 6, and such procedure comprises the steps of:

(601) receiving a second trigger key code after a desired function switching key 108 is triggered;

(602) displaying a third menu on the second display unit 105 for setting a user-defined function switching key or a built-in function switching key;

(603) determining whether or not a second signal of a selected option “User-defined function switching key” is selected; if yes, then go to Step (604), or else go to Step (608);

(604) providing users a position on the second display unit 105 and proximate to the function switching key 108 to input or edit a content information (such as a Stereo function) corresponding to the function switching key 108 according to the function switching key 108 represented by the second trigger key code;

(605) recording the content information corresponding to the second trigger key code into the storage unit 25;

(606) displaying the inputted or edited content information on the second display unit 105 and at a position proximate to the function switching key 108, for reminding users about the operation instruction represented by the function switching key 108;

(607) driving the IR receiving unit 23 to receive an external instruction code, corresponding the instruction code to the second trigger key code, and storing the instruction code into the storage unit 25, such that the remote control apparatus 1 can learn the unique operation instruction corresponding to the function switching key 108, and after the function switching key 108 is triggered, the instruction code corresponds to the IR transmitting unit 24; and

(608) setting a unique operation instruction preinstalled in the function switching key 108 according to the universal appliance key code table 251.

When the remote control apparatus 1 is used, the user-defined content information is displayed on the first display unit 102 and at a position proximate to each device switching key, or the user-defined content information is displayed on the second display unit 105 and at a position proximate to each function switching key 108. Users can know about the controlled appliance corresponding to each device switching key 107 according to the content information. The device switching key 107 can be switched to control a controlled appliance or a unique operation instruction or set the function key 104 to avoid small symbols printed on the press key that may confuse the users.

While the invention herein disclosed has been described by means of specific embodiments, numerous modifications and variations could be made thereto by those skilled in the art without departing from the scope and spirit of the invention set forth in the claims.

What is claimed is:

1. A method of setting remote control content, applied to a remote control apparatus having two display units, and said remote control apparatus installing a plurality of function key modules and two switching key modules, and said each switching key module corresponding to said each display unit and disposed proximate to said each display unit and having a plurality of switching keys, and said each switching key corresponding to said each function key module of a different remote control content, and said method comprising the steps of:
entering into a setting mode;
providing a content information for setting said each switching key;
displaying a user-defined content information on said each display unit proximate to said each switching key;
recording said user-defined content information and a corresponding switching key code into said remote control apparatus;
providing an operation instruction of said user-defined function key module corresponding to said each switching key; and
defining said function key module corresponding to at least one switching key into said remote control apparatus, after said each operation instruction is defined.

2. The method of claim 1, wherein said setting mode is a first setting mode corresponding to a device switching key module, and said switching key is provided for controlling a device switching key of a controlled appliance, and said remote control apparatus bases on said first setting mode to carry out a procedure comprising the steps of:
receiving a first trigger key code produced after a desired setting device switching key is triggered;
providing an option of a user-defined device switching key or a built-in device switching key on said display unit;
if an option of said user-defined device switching key is selected, then said remote control apparatus provides users a position on said display unit and proximate to said device switching key to input or edit a content information representing said device switching key according to a device switching key representing said first trigger key code;
after said content information is inputted or edited, said remote control apparatus records a content information corresponding to said first trigger key code into a storage unit of said remote control apparatus;
displaying said inputted or edited content information at a position on said display unit and proximate to said device switching key; and
setting an operation instruction for each of said plurality of function key modules of said remote control apparatus according to the function of said controlled appliance.

3. The method of claim 2, wherein if an option of said built-in switching key is selected, then said remote control apparatus sets an operation instruction of a controlled appliance for said device switching key according to a universal appliance key code table preinstalled in said storage unit.

4. The method of claims 1, wherein said setting mode is a second setting mode corresponding to a function switching key module, and said switching key is a function switching key representing an operation instruction, and said remote control apparatus bases on said second setting mode to carry out a procedure comprising the steps of:
receiving a second trigger key code produced after a desired setting device switching key is triggered;
providing an option of setting a user-defined device switching key or a built-in device switching key on said display unit;
if an option of said user-defined device switching key is selected, then said remote control apparatus provides users a position on said display unit and proximate to said device switching key to input or edit a content information representing said device switching key according to a device switching key representing said second trigger key code;
after said content information is inputted or edited, said remote control apparatus records a content information corresponding to said second trigger key code into a storage unit of said remote control apparatus;
displaying said inputted or edited content information at a position on said display unit and proximate to said device switching key; and
receiving an external instruction code and corresponding said instruction code to said second trigger key code, and storing said instruction code into said storage unit, such that said remote control apparatus learns said operation instruction corresponding to said function switching key.

5. The method of claims 3, wherein said setting mode is a second setting mode corresponding to a function switching key module, and said switching key is a function switching key representing an operation instruction, and said remote control apparatus bases on said second setting mode to carry out a procedure comprising the steps of:
receiving a second trigger key code produced after a desired setting device switching key is triggered;
providing an option of setting a user-defined device switching key or a built-in device switching key on said display unit;
if an option of said user-defined device switching key is selected, then said remote control apparatus provides users a position on said display unit and proximate to said device switching key to input or edit a content information representing said device switching key according to a device switching key representing said second trigger key code;
after said content information is inputted or edited, said remote control apparatus records a content information corresponding to said second trigger key code into a storage unit of said remote control apparatus;
displaying said inputted or edited content information at a position on said display unit and proximate to said device switching key; and
receiving an external instruction code and corresponding said instruction code to said second trigger key code, and storing said instruction code into said storage unit, such that said remote control apparatus learns said operation instruction corresponding to said function switching key.

6. The method of claim 4, wherein if an option of said built-in function switching key is selected, then said remote control apparatus sets an operation instruction of a controlled appliance for said device switching key according to a universal appliance key code table preinstalled in said storage unit.

7. The method of claim 5, wherein if an option of said built-in function switching key is selected, then said remote control apparatus sets an operation instruction of a controlled appliance for said device switching key according to a universal appliance key code table preinstalled in said storage unit.

8. A remote control apparatus for setting remote control contents, comprising: a casing;
a circuit board, installed in said casing;
at least one setup key, with an end disposed on said casing and another end disposed in said casing and coupled to said circuit board, such that if said setup key is triggered to issue a setup signal, said remote control apparatus will enter into a setting mode;
at least one function key module, including a plurality of function keys, with an end disposed on said casing and another end disposed in said casing and coupled to said circuit board, for issuing different operation instructions respectively when said function keys are triggered;
two display units, disposed on said casing and coupled with said circuit board in said casing;
two switching key modules, corresponding to different display units, and separately including a plurality of switching keys disposed on said casing at positions corresponding to said display unit, and disposed in said casing and coupled to said circuit board, and said switching keys are triggered to issue a switching key code separately, for switching said function key module of said remote control apparatus corresponding to said switching key; and
a control unit, installed on said circuit board and connected to said each display unit, switching key module, setup key module and function key module, such that after said control unit receives a switching key code in said setting mode, said switching key code is received and stored at a position to be displayed on said display unit and proximate to said switching key, and presenting a content information of said switching key, and defining an operation instruction of said each function key module corresponding to at least one switching key, and recording said operation instruction into said remote control apparatus.

9. The remote control apparatus of claim 8, wherein said circuit board further comprises a storage unit coupled to said control unit for storing said switching key code and an operation instruction of a corresponding function key module.

10. The remote control apparatus of claim 9, wherein said storage unit further builds in a universal appliance key code table for recording different codes according to different types, model numbers and functions of an electric appliance.

11. The remote control apparatus of claim 8, wherein said circuit board further comprises an IR receiving unit coupled to said control unit for receiving an external control signal.

12. The remote control apparatus of claim 8, wherein said function key is one selected from the collection of a multimedia playback key, a multi-directional control key, a mouse function control key and an alphanumeric key.

13. The remote control apparatus of claim 8, wherein said each setup key is one selected from the collection of previous, next and exit keys.

14. The remote control apparatus of claim 8, wherein said switching key module is one selected from the collection of a device switching key and a function switching key.

15. The remote control apparatus of claim 8, wherein said remote control apparatus further comprises a USB module installed on said circuit board, for externally accessing a code of a USB connector disposed on said casing.
